(19) United States
(12) Patent Application Publication
(10) Pub. No.: US 2008/0118802 A1
(43) Pub. Date: May 22, 2008

(54) Fully Catalyzed Membrane Assembly With Attached Border

(76) Inventors: Peter Szrama, Newark, DE (US); Oliver Teller, Muenchen (DE); Anton Killer, Dietramszell (DE)

Correspondence Address: Allan M. Wheatcraft;W. L. Gore & Associates, Inc., 551 Paper Mill Road, P. O. Box 9206, Newark, DE, 19714-9206, US

(21) Appl. No.: 11/560,591

(22) Filed: Nov. 16, 2006

(51) Int. Cl. H01M 8/10

(52) U.S. Cl. 429/30

(57) ABSTRACT

A catalyst coated membrane assembly comprising a solid polymer electrolyte membrane, an electrode that covers substantially one entire face of said solid polymer electrolyte membrane, and a structural film layer attached to at least two opposing outer regions of said electrode such that it partially overlaps the open face of said electrode. The use of structural film layer allows for high volume, high yield manufacturing of assemblies, leading to reduced assembly cost.

### FIELD OF THE INVENTION

This invention pertains to polymer electrolyte membrane (PEM) fuel cells and, more particularly, to a fully catalyzed membrane assembly with an attached border for use in PEM fuel cells.

### BACKGROUND OF THE INVENTION

A central component of a polymer electrolyte membrane fuel cell (PEMFC) is the ion exchange membrane. Typically, the membrane is disposed between an anode and a cathode. The electrodes contain catalysts that promote the reactions of fuel (the anode for hydrogen fuel cells) and the oxidant (oxygen for hydrogen fuel cells), and may comprise any various noble metals, or other well known catalysts. A “catalyst coated membrane” (CCM) means the combination of at least one membrane and at least one electrode containing a catalyst that is adjacent to the membrane. A fully catalyzed membrane assembly (FCMA) is a CCM where at least one electrode covers substantially the entire face of the membrane to which it is adjacent (i.e., the electrode is co-extensive with the membrane). A typical catalyst coated membrane has an anode bonded to one surface of the membrane and a cathode bonded to the other surface of the membrane, but such bonding is not essential.

In a PEMFC the membrane facilitates the transmission of ions from one electrode to the other during operation of the fuel cell. Ideally, the membrane is as thin as possible to allow the ions to travel as quickly as possible between the electrodes. As membranes get thinner, however, they typically get weaker. Therefore, reinforcement of the membrane is needed. One solution to this is the incorporation of a reinforcement within the membrane. An example of such a solution is embodied in U.S. Pat. No. RE37,307 to Bahar et al, disclosing the use of a porous material such as expanded polytetrafluoroethylene (PTFE) as a support for a membrane.

There is a need, however, for even further reinforcement of a membrane and the CCM formed from it in certain situations. When a membrane is used in an assembly that includes gas diffusion layers, which are typically made of carbon fiber paper, the carbon fibers are known to occasionally puncture the membrane, thereby short circuiting the assembly and decreasing or destroying its performance. Puncture of the assembly can occur during the manufacturing process of the assembly itself, or it can occur during the seal molding process due to mold clamping pressures. Puncture can also occur over time during use, or through handling during processing or stack assembly. Protecting the membrane from gas diffusion media fiber puncture is therefore desirable.

Further, additional support for the membrane and CCM is frequently necessary to increase overall dimensional stability. Environmental conditions such as humidity, or simply handling of the membrane, may cause damage to the membrane. Additional reinforcement and support to increase this dimensional stability is desired.

A typical attempt to provide such additional support involves imbibing an elastomeric material directly into the outer regions of the electrodes so that the face of the electrode as well as the edge of the electrode are sealed with elastomer. As used herein, the “face” of the membrane is the surface of the membrane that is perpendicular to the predominant ion flux through the membrane during fuel cell operation. The “face” of the electrode is the surface of the electrode opposite the membrane-electrode interface that is perpendicular to the predominant ion flux through the membrane during fuel cell operation. The “edge” of the electrode is the surface parallel to the predominant ion flux through the membrane and perpendicular to the face of the electrode. The “outer region” of the electrode is a volume of the electrode adjacent to the edge of the electrode, and includes the volume adjacent to the edge from the face of the electrode to the electrode/membrane interface, or any portion thereof. A disadvantage of imbibing an elastomeric material directly into the outer regions of the electrodes is that during forming of the elastomer, the electrode and/or membrane can easily be damaged. There are thus high material and processing costs associated with this design. A better assembly is desired that will have structural support for enhanced dimensional stability and protection from puncture, and is also more efficient to produce than existing designs.

As used herein, “assembly” means the combination of at least one membrane and a structural support, but “assembly” may also include other components as well, such as electrodes, gas diffusion media, sealing gaskets, etc.

### SUMMARY OF THE INVENTION

The invention embodied herein is a catalyst coated membrane assembly that includes a solid polymer electrolyte membrane, an electrode that covers substantially at least one entire face of said solid polymer electrolyte membrane, and a structural film layer attached to at least two opposing outer regions of said electrode such that it partially overlaps the open face of said electrode. In additional embodiments, this CCM assembly may have a structural film layer that is attached to the electrode with an adhesive, or it may have a structural film layer that imbibes at least a portion of the outer regions of said electrode. The use of such an assembly in a fuel cell is also an embodiment of the invention.

Additional embodiments of the invention include a catalyst coated membrane that includes a solid polymer electrolyte membrane, an electrode that covers substantially at least one entire face of said solid polymer electrolyte membrane, and a structural film layer attached to all outer regions of the electrode such that it partially overlaps the open face of the electrode. Further, the structural film layer may be attached to the electrode with an adhesive. Additionally, the adhesive may imbibe at least a portion of said outer portion of said electrode. These CCMs may use a solid polymer electrolyte that comprises a perfluorosulfonic acid ionomer, and/or expanded polytetrafluoroethylene. The structural film layer in these embodiments may comprise polyethylene naphthalate or a fluorothermoplastic comprising tetrafluoroethylene. When used, the adhesive may comprise a fluorothermoplastic comprising tetrafluoroethylene.

Additional embodiments of the invention include assemblies using any of the catalyst coated membranes described in the previous two paragraphs wherein the assembly additionally includes at least one gas diffusion layer. Further, any of these assemblies may also include a sealing gasket.

Yet additional embodiments of the invention include catalyst coated membrane assemblies comprising a solid polymer electrolyte membrane having two faces, a first electrode that covers substantially the entire first face of said polymer electrolyte membrane, a second electrode that covers substantially the entire second face of said polymer electrolyte membrane, a first structural film layer attached to at least two opposing outer regions of the first electrode such that it partially overlaps the open face of the electrode to which it is attached, and a second structural film layer attached to either (i) at least two opposing outer regions of said second electrode such that it partially overlaps the open face of the electrode to which it is attached; or (ii) said first structural film layer; or both (i) and (ii). The use of such an assembly in a fuel cell is also an embodiment of the invention.

Further embodiments of the invention include catalyst coated membrane assemblies of the previous paragraph wherein either the first structural film layer or the second structural film layer, or both are attached to the electrode with an adhesive, or the first or the second structural film layer imbibes at least a portion of said outer regions of the first or the second electrode to which it is attached.

In other embodiments of the invention the catalyst coated membrane assemblies comprise a solid polymer electrolyte membrane having two faces, a first electrode that covers substantially the entire first face of said polymer electrolyte membrane, a second electrode that covers substantially the entire second face of said polymer electrolyte membrane, a first structural film layer attached to all the outer regions of the electrode such that it partially overlaps the open face of the electrode to which it is attached, and a second structural film layer attached to either (i) at least two opposing outer regions of said second electrode such that it partially overlaps the open face of the electrode to which it is attached; or (ii) said first structural film layer; or both (i) and (ii). These assemblies may have either the first or the second structural film layer attached to the first or the second electrode with an adhesive. Further, the adhesive may imbibe at least a portion of the outer portion of either the first electrode or the second electrode. These CCMs may use a solid polymer electrolyte that comprises a perfluorosulfonic acid ionomer, and/or expanded polytetrafluoroethylene. The structural film layer in these embodiments may comprise polyethylene naphthalate or a fluorothermoplastic comprising tetrafluoroethylene. When used, the adhesive may comprise a fluorothermoplastic comprising tetrafluoroethylene. The assemblies may also include at least one gas diffusion layer, and may further include a sealing gasket.

Yet more embodiments of the invention include a process for producing a catalyst coated membrane assembly comprising (a) providing a fully catalyzed membrane assembly comprising a solid polymer electrolyte membrane and at least one electrode attached to it; and (b) attaching a structural film layer to at least two opposite outer regions of said electrode such that it partially overlaps the open face of said electrode. Such processes may also use an adhesive to attach the structural film layer in step (b), and the adhesive may be a thermoplastic polymer, or a fluorothermoplastic comprising tetrafluoroethylene. Further embodiments of the invention include an additional step, (c), where a gas diffusion layer is applied to at least one of said electrodes, or where a sealing gasket is applied to said structural film layer; or two additional steps, (c) and (d), where both a gas diffusion layer and a sealing layer are applied to the assembly.

### BRIEF DESCRIPTION OF THE DRAWINGS

FIGS. 1(a)-(c) are cross-sectional side views of exemplary embodiments of the invention illustrating an assembly with a single structural film layer.

FIGS. 2(a)-(c) are cross-sectional side views of exemplary alternative embodiments of the invention illustrating an assembly with a single structural film layer.

FIGS. 3(a)-(c) are cross-sectional side views of exemplary embodiments of the invention illustrating an assembly with two structural film layers.

FIGS. 4(a)-(c) are cross-sectional side views of exemplary alternative embodiments of the invention illustrating an assembly with a two structural film layers.

FIGS. (a)-(c) are cross-sectional side views of exemplary alternative embodiments of the invention illustrating an assembly with two structural film layers.

FIGS. 6(a)-(c) are cross-sectional side views of exemplary alternative embodiments of the invention illustrating an assembly with two structural film layers.

FIGS. 7(a)-(c) are cross-sectional side views of exemplary alternative embodiments of the invention illustrating an assembly with two structural film layers.

FIGS. 8(a)-(c) are cross-sectional side views of exemplary alternative embodiments of the invention illustrating an assembly with two structural film layers.

FIGS. 9(a)-(c) are cross-sectional side views of exemplary alternative embodiments of the invention illustrating an assembly with two structural film layers.

FIGS. 10(a)-(b) are top views of exemplary embodiments of the invention.

FIGS. 11(a)-(c) are cross-sectional side views of exemplary embodiments of the invention where the assembly includes gas diffusion media.

FIG. 12 is a cross-sectional side view of an exemplary embodiment of the invention where the assembly includes a sealing gasket.

FIG. 13 is a schematic illustration of one embodiment of a manufacturing process for making the invention having a structural film layer.

FIGS. 14(a)-(b) is a schematic illustration of another embodiment of a manufacturing process for making the invention having a structural film layer.

### DETAILED DESCRIPTION OF THE INVENTION

The instant invention is embodied in an assembly with an electrode that is co-extensive with a membrane, i.e. covers the entire face of the membrane, in combination with a structural film layer that overlaps the outer region of the face of one or both electrode(s). As used herein, “structural film layer” means a hard, non-elastomeric solid. It is not compressible to any significant degree. Its function is not to perform sealing. Non-elastomeric polymers as used herein are polymers that will not return to substantially their original length after being stretched repeatedly to at least twice their original length at room temperature. As used herein “overlaps” or “overlapping” means the structural film layer is over, and covering, a portion of the outer region of the face of one or both electrode(s).

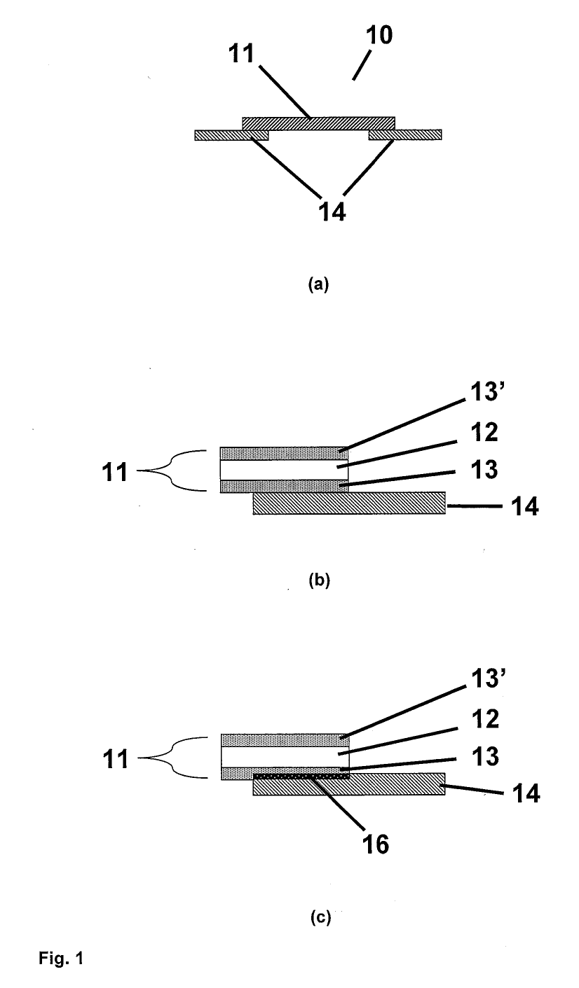

A cross section of an exemplary embodiment of the invention is shown in FIG. 1(a), where an assembly 10 is shown with a CCM 11 mated to a structural film layer 14. Two different exemplary embodiments of this structure are illustrated in FIGS. 1(b) and 1(c) by enlargements of one side of the overlapping region of the structural film layer and the CCM. In FIG. 1(b) the CCM 11 comprises a membrane 12 and two electrodes 13 and 13′ The structural film layer 14 overlaps the electrode 13 and is bonded to it. In FIG. 1(c) the structural film layer 14 has imbibed into the outer region of the electrode 13. The imbibed portion 16 may include only a portion of the outer region (as shown in the Figure) or it my include the entire outer region of the overlapped structural film material from the face of the electrode to the electrode-membrane interface (not shown). One difference between the embodiments shown in FIGS. 1(b) and 1(c) is that in the former the edge of the electrode 13 is substantially open, while in the latter the edge is partially or entirely covered with the structural film material.

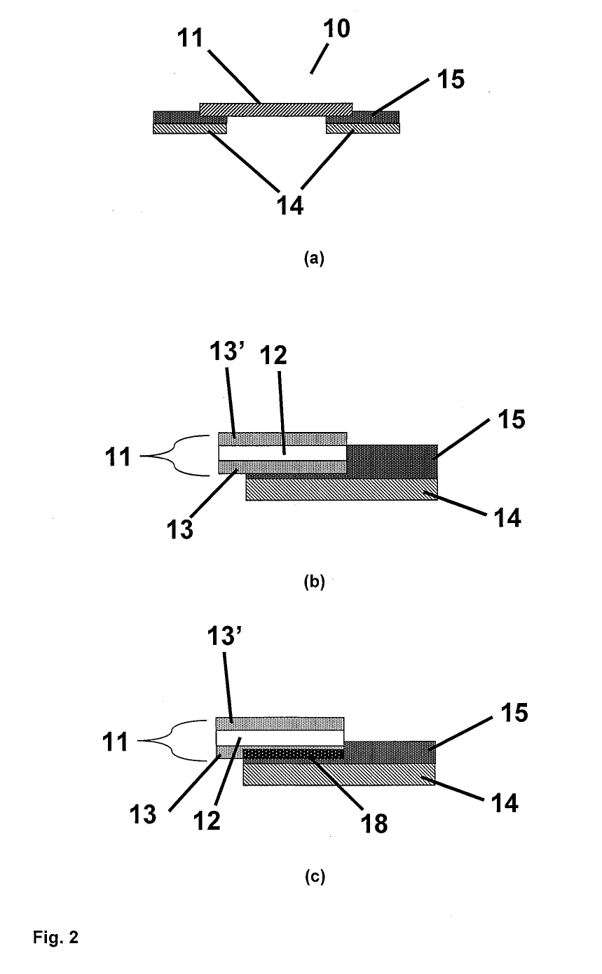

FIG. 2 shows another exemplary embodiment of the invention. Assembly 10 is mated to a structural film layer 14 by the use of an adhesive 15. Two different exemplary embodiments of this structure are illustrated in FIGS. 2(b) and 2(c) by enlargements of one side of the overlapping region of the structural film layer and the CCM. In FIG. 2(b), CCM 11 comprises a membrane 12 and two electrodes 13 and 13′. The structural film layer 14 overlaps electrode 13 and is bonded to it through adhesive 15. In FIG. 2(c) the adhesive 15 has imbibed into the outer region of the electrode 13′. The imbibed portion 18 may include only a portion of the outer region (as shown in the Figure) or it my include the entire outer region of the overlapped structural film material from the face of the electrode to the electrode-membrane interface (not shown). In these embodiments, the amount and type of adhesive as well as the processing conditions used can be controlled as desired to manipulate the amount of coverage of the edge of the CCM 11. In other words the adhesive can cover very little or none of the edge of electrode 13, all of it, or just a portion of it. Further, if sufficient adhesive is used it may cover the edge of the membrane and even the edge of the opposite electrode 13′. A preferable embodiment has at least the edge of electrode 13 fully covered as this prevents internal leakage of gas from one side of the assembly to the other. Preventing gas leakage is a benefit of the invention. The gas sealing means may be the adhesive itself, or imbibing of the structural film layer into the electrode. “Gas sealing” means that the reactant and oxidant gases are separated by at least one substantially non-porous solid. Additionally, the overlapping region of the electrode may have holes placed into it, or it may have surface roughness added, for example by knurling the surface, if additional mechanical locking of the adhesive to the MEA is desired.

The electrodes 13 and 13′ shown in FIGS. 1-2 may be of different composition, as may be required depending on whether they are used as a cathode or anode in a fuel cell. The structural film layer 14 shown in FIGS. 1-2 may be placed on the electrode that is used as the anode, or on the electrode that is used as the cathode. Where adhesive is used for bonding (FIG. 2), adhesive may also be present on the opposite face of the structural film layer. In the embodiments where the structural film layer has adhesive on both surfaces its composition need not be the same on each surface.

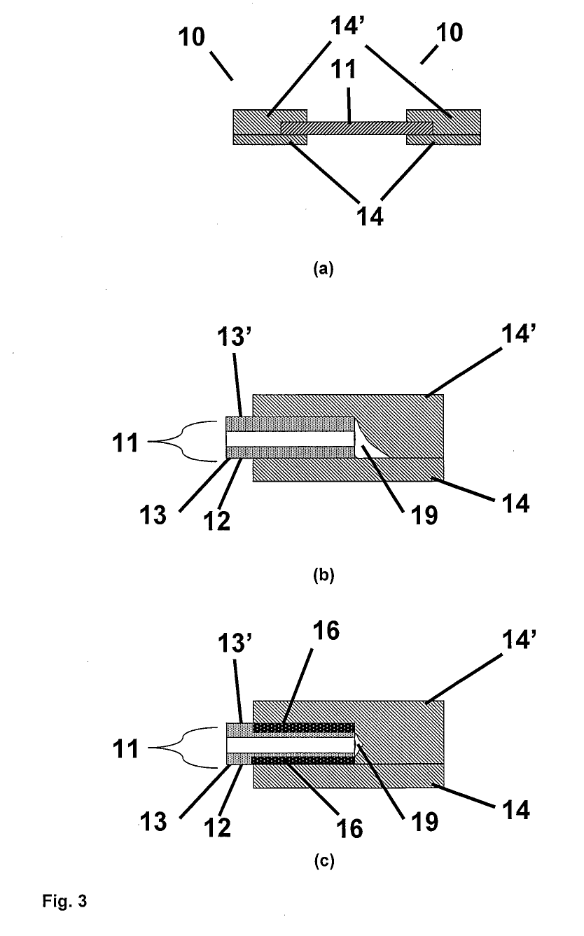

Additional embodiments of the invention are shown in FIGS. 3-9. In these embodiments two structural film layers are used. In FIG. 3, two structural film layers 14 and 14′ are attached to both the first and second electrodes 13 and 13′ of the CCM 11 so that each one overlaps its corresponding electrode by approximately the same amount. In the embodiment shown in FIG. 3(b) the structural film layers do not imbibe the electrodes, while in the embodiment of FIG. 3(c), there is a region 16 where the structural film layer does imbibe into the electrode. In these embodiments a small void space 19 may optionally be present. Its presence and size will depend on the nature of the bonding process of the structural film layer to the electrodes, and composition of the structural film layer. Higher heat and pressure will decrease the void space volume as will lower melting temperature thermoplastic polymers that will have a higher tendency to flow at lower temperatures. Imbibing into the electrode will also tend to reduce the void space. In FIG. 3(c) the imbibed portion 16 may include only a portion of the outer region (as shown in the Figure) or it my include the entire outer region of the overlapped structural film material from the face of the electrode to the electrode-membrane interface (not shown). The extent of imbibing into the two electrodes 13 and 13′ can be different if so desired.

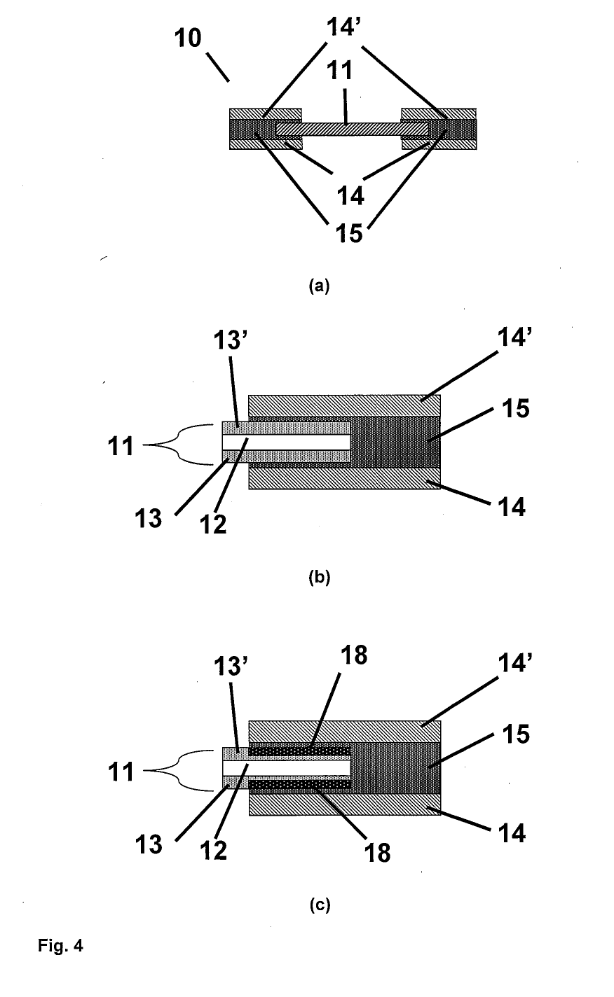

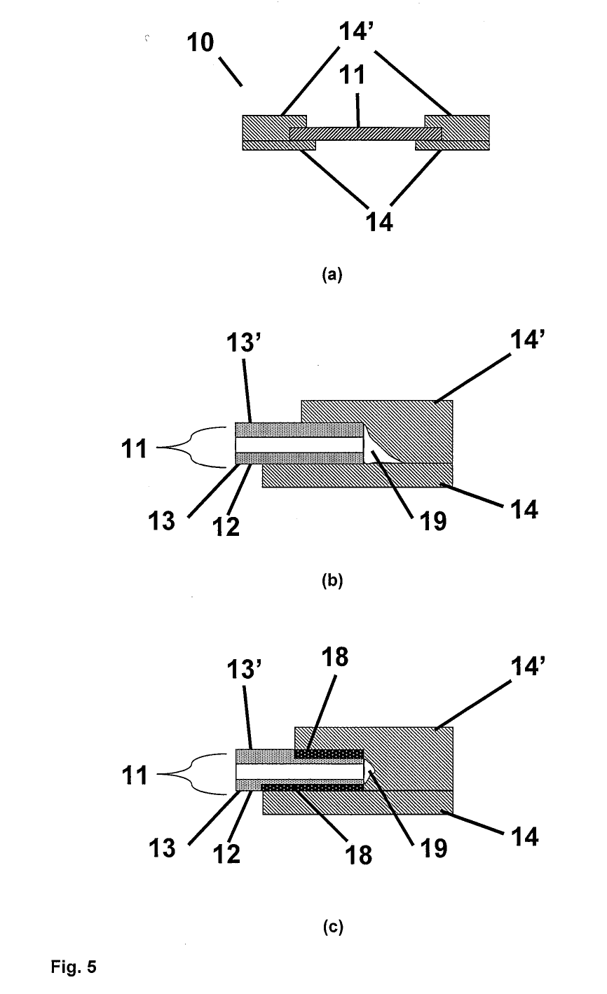

In FIG. 4, an adhesive 15 is used to bond the two structural film layers to their corresponding electrodes. In FIG. 4b, the two structural film layers 14 and 14′ are attached to both the first and second electrodes 13 and 13′ of the membrane 12 using adhesive 15 so that each one overlaps its corresponding electrode by approximately the same amount. In the embodiment shown in FIG. 4(b) the structural film layers do not imbibe the electrodes, while in the embodiment of FIG. 4(c), they do. In FIG. 4(c) the imbibed portion 18 may include only a portion of the outer region (as shown in the Figure) or it may include the entire outer region of the overlapped structural film material from the face of the electrode to the electrode-membrane interface (not shown). The extent of imbibing into the two electrodes 13 and 13′ can be different if so desired.

Yet a further embodiment of the invention is illustrated in FIG. 5. This embodiment illustrates that the overlap need not be identical when two structural film layers are used. This embodiment is similar to that shown in FIG. 3, except that the overlap of the structural film layer 14′ is less than that of structural film layer 14. The other features of this embodiment are similar to those described for FIG. 3.

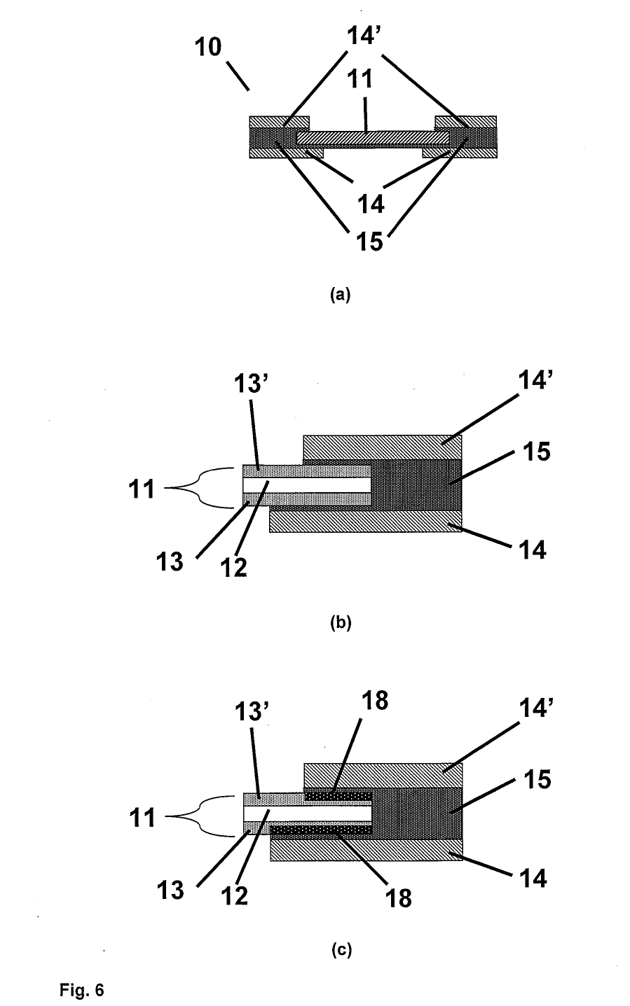

A further embodiment of the invention is illustrated in FIG. 6. This embodiment illustrates that the overlap need not be identical when two structural film layers are used when an adhesive is present to enhance bonding. This embodiment is similar to that shown in FIG. 4, except that the overlap of the structural film layer 14′ is less than that of structural film layer 14. The other features of this embodiment are similar to those described for FIG. 4.

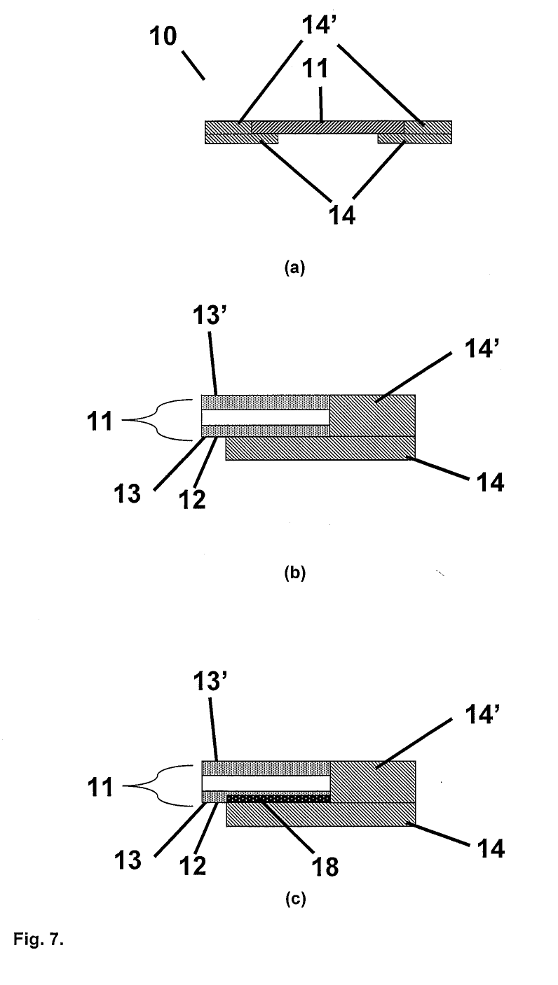

Yet one more embodiment of the invention is shown in FIG. 7, where the second structural film layer 14′ does not overlap the second electrode 13′ at all, but rather is butted up against the edge of the CCM 11, and bonded to the first structural film layer 14. The first structural film layer can be partially imbibed into the electrode (18 in FIG. 7(c)), fully imbibed (not shown) or not imbibed at all (FIG. 7(b)).

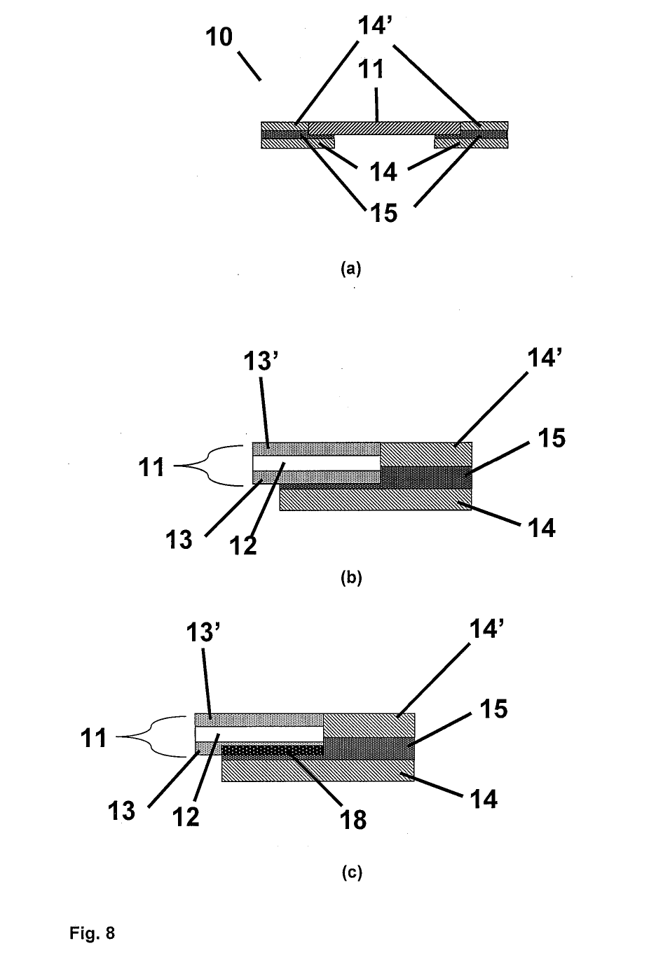

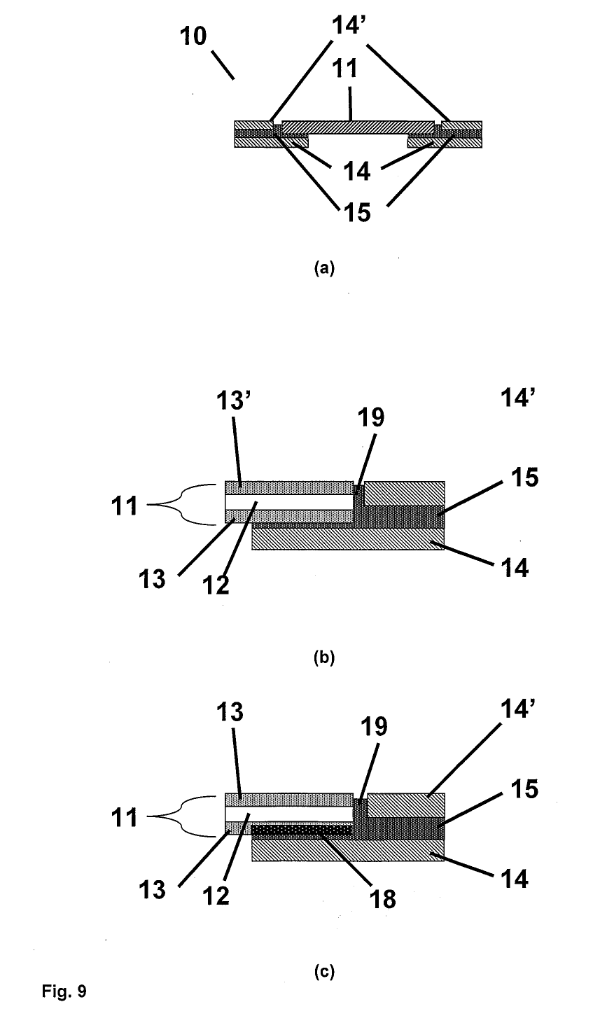

In yet more embodiments of the invention shown in FIG. 8 and 9, a second structural film layer does not cover the outer portion of the second electrode 13′, but is bonded to the first structural film layer 14 with adhesive 15. The adhesive used for bonding can be partially imbibed into the first electrode (18 in FIG. 8(c) and FIG. 9(c)), fully imbibed (not shown), or not imbibed at all (FIG. 8(b) and FIG. 9(b)). Optionally, the adhesive may also not cover the outer portions of the first electrode and only be present between the first and second structural film layers. Additionally, the second structural film layer 14′ may be butted up against the edge of the CCM 11 as shown in FIG. 8, or it may be adjacent to it as shown in FIG. 9. In the latter case, it is preferable if the adhesive fills the gap 19 between the CCM and the second structural film layer, though this is not essential.

In the embodiments illustrated in FIGS. 3-9 where there are two structural film layers present, the two layers need not have the same composition, though this is preferable. Furthermore, when adhesive is used for bonding in these embodiments, the adhesive need only be present on one of the two structural film layers. Alternatively, it may be present on one or both surfaces of the two structural film layers. In the embodiments where the structural film layer has adhesive on both surfaces its composition need not be the same on each surface. Furthermore, the composition used on the two structural film layers may be different is so desired.

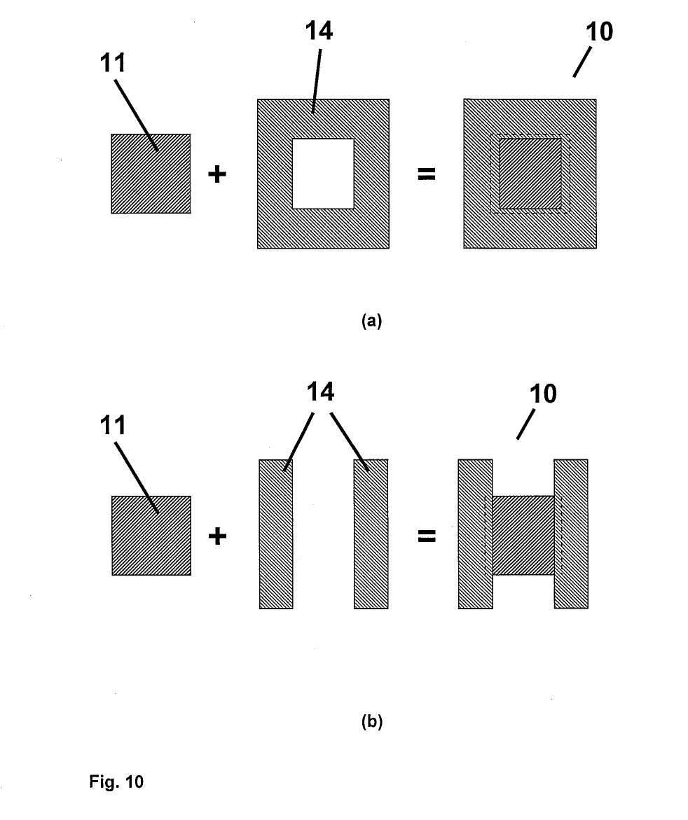

The preferred shape of the assemblies produced by the invention are substantially rectangular, though any area may be used including circular, elliptical or other odd-shaped area if desired. For substantially rectangular assemblies that have four definable edges, the structural film layer is preferably present on all four edges as illustrated in FIG. 10(a), which shows a plan view looking down of the top of an assembly 10 having a structural film layer 14 from the top face of the CCM 11. In another embodiment of the invention two strips of structural film layer 14 may be used so that the final assembly has the structural film layer present on only opposing edges of the CCM 11 as shown in FIG. 10(b). As used herein “opposing edges” means those edges that are substantially opposite one another. For rectangular shaped assemblies the opposing edges are substantially parallel to one another as shown in FIG. 10(b), but this may not be the case for non-rectangular shapes.

The inventive assemblies on the invention may use any polymer electrolyte membrane known in the art, including but not limited to compositions comprising phenol sulfuric acid; polystyrene sulfonic acid; fluorinated-styrene sulfonic acid; perfluorinated sulfonic acid; sulfonated Poly(aryl ether ketones); polymers comprising phthalazinone and a phenol group, and at least one sulfonated aromatic compound; aromatic ethers, imides, aromatic imides, hydrocarbon, or perfluorinated polymers in which an ionic acid functional group or groups is attached to the polymer backbone. Such ionic acid functional groups may include, but are not limited to, sulfonic, sulfonimide or phosphonic acid groups. Additionally, the ion exchange material may further optionally comprise a reinforcement to form a composite membrane. Preferably, the reinforcement is a polymeric material. The polymer is preferably a microporous membrane having a porous microstructure of polymeric fibrils, and optionally nodes. Such polymer is preferably expanded polytetrafluoroethylene, but may alternatively comprise a polyolefin, including but not limited to polyethylene and polypropylene. An ion exchange material is impregnated throughout the membrane, wherein the ion exchange material substantially impregnates the microporous membrane to render an interior volume of the membrane substantially occlusive, substantially as described in Bahar et al, RE37,307, thereby forming the composite membrane. A particularly preferable membrane is GORE-SELECT® ionomer membrane available from W. L. Gore & Associates.

The electrodes 13 and 13′ of FIGS. 1-9 may be any composition known in the art, including but not limited to electrodes comprising platinum or other noble metals that may act as catalysts for oxygen reduction or fuel oxidation, and may also include various other components such as ionomers, pores, or other species. A particularly preferable electrode is a porous composite electrode containing platinum or a platinum alloy supported on carbon and a perfluorosulfonic acid polymer.

The composition of the structural film layer may include, but is not limited to various thermoplastic or thermosetting polymers such as PEN (polyethylene naphthalate); non-porous polypropylene; polystyrene; rigid polyvinylch lride; polyimides; acylonitrile-butadiene-styrene (ABS) copolymer; polyamides; acrylics, acetals; hard cellulosics; polycarbonates; polyesters; phenolics; urea-milamines; epoxies; urethanes; fluorothermoplastic polymers, such as FEP (a polymer of tetrafluoroethylene and hexafloropropylene), or THV (a terpolymer of tetrafluoroethylene, hexafluoropropylene and vinylidene fluoride) and glass filled silicone thermosets; metal foils, such as aluminum, gold, or silver foil or the like; or ceramics, such as thin layers of alumina or silica or the like.

A preferable structural film layer is polyethylene naphthalate (PEN) material. As is well known in the art, the PEN material may have a primer on it to enhance bonding if desired. Preferably, the structural film layer is less than about 0.075 mm (0.003 inches) thick. The structural film layer may also have an adhesive in it or on at least one of its surfaces to promote bonding to the electrode. Any suitable adhesive can be used, but fluorothermoplastics such as terpolymers of tetrafluoroethylene, hexafluoropropylene and vinylidene fluoride (for example, Dyneon™ THV fluorothermoplastics) are preferred. In those cases where an adhesive is desired on both sides of the structural film layer, the composition used on each side may be different. For example, it may be desirable to have a higher melting point adhesive on one side than the other to aid in multistep manufacturing processes where two structural film layers are used. The adhesive may be applied to the structural film layer using any standard processes known in the art, including but not limited to lamination, extrusion or dip coating.

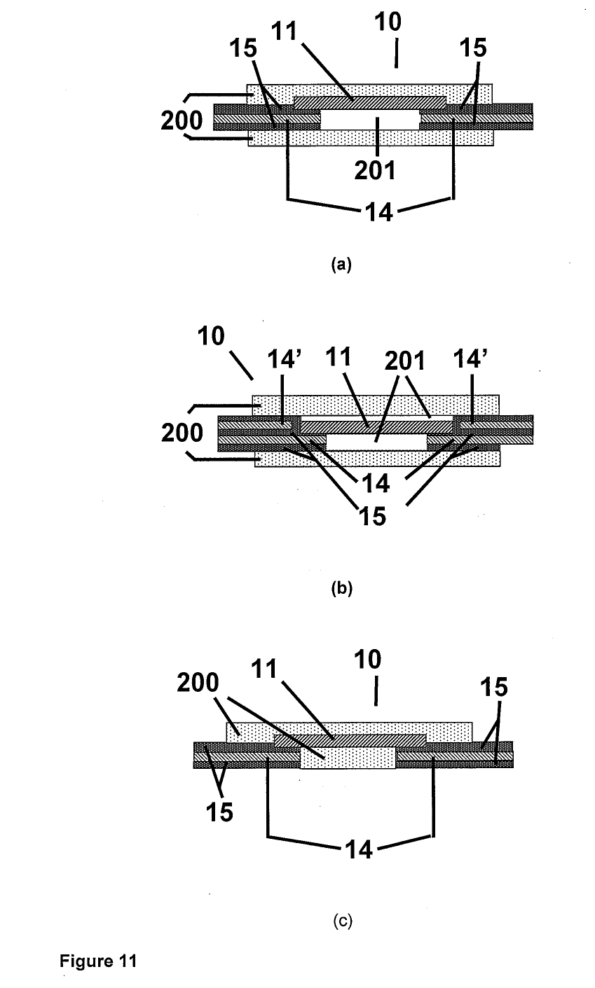

The assemblies of the invention may include additional components if desired, including but not limited to gas diffusion layers on one or both electrodes, and/or sealing materials applied to the electrodes, structural film layer or layers, or to the gas diffusion layer if it is present. For example, gas diffusion layers may be applied to the one or both electrodes in each of the embodiments illustrated in FIGS. 1-9. Two specific embodiments illustrative of these embodiments are shown in FIG. 11, where a gas diffusion layer 200 is applied to the top and bottom surface of the CCM 11. FIG. 11(a) illustrates one embodiment with a single structural film layer, while FIG. 11(b) illustrates an embodiment with two structural film layers. In both cases, adhesive 15 is applied to both surfaces of the structural film layer. Although this is not required, it is preferable because it promotes bonding of the gas diffusion layer to the assembly. As shown, the structural film layers extend beyond the gas diffusion layers, but they may also be coextensive with them, or in the case of FIG. 11(b), one structural film layer may be coextensive with the gas diffusion layers, and the other not. The adhesive layer may also optionally be infiltrated into the gas diffusion layer (not shown in FIG. 11) if desired. In the embodiments shown in FIG. 11, a gap 201 between the CCM and gas diffusion layer is shown. The extent of this gap can be minimized and/or controlled if desired because the gas diffusion layers are somewhat compliant and tend to fill the gap during placement if pressure is applied. Alternatively, the gap is generally reduced during fuel cell assembly where relatively large pressures are applied. It can also be eliminated if desired by reducing the size of gas diffusion layer as shown in FIG. 11(c) so that is only contacts the CCM and does not overlap the structural film layer.

In each of the embodiments of the invention shown in FIGS. 1-11, a gasket can be placed or molded to the outside of the assembly if additional sealing is required. The gasket may be coextensive with the structural film layer, it may cover the edge of the structural film layer, or the structural film layer may extend beyond the gasket. The inventive embodiments described herein are particularly desirable for molding a sealing gasket because the structural film layer(s) are beyond the CCM and/or gas diffusion layer(s). They thus provide a solid, hard surface for molding, thereby making the molding process easier, and increasing its yield. Furthermore, the molding surface is far away from the active area of the CCM, thus minimizing the potential for damage to it during the molding process.

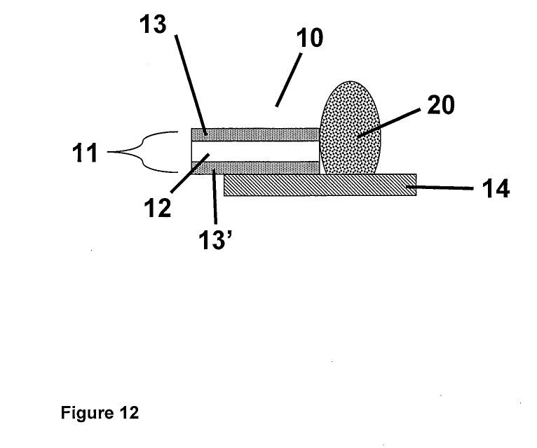

A gasket may be required in those embodiments where the structural film layer and/or the adhesive do not seal the edge of at least one electrode and/or the membrane. In those situations, a gasket can provide the sealing necessary to prevent gas from leaking between the anode and cathode gas chambers. One illustrative example is shown in FIG. 12, where a cross-section of one edge of an inventive embodiment is shown. The gasket 20 is molded onto the structural film layer sealing the edge of CCM 11 to prevent gas cross over.

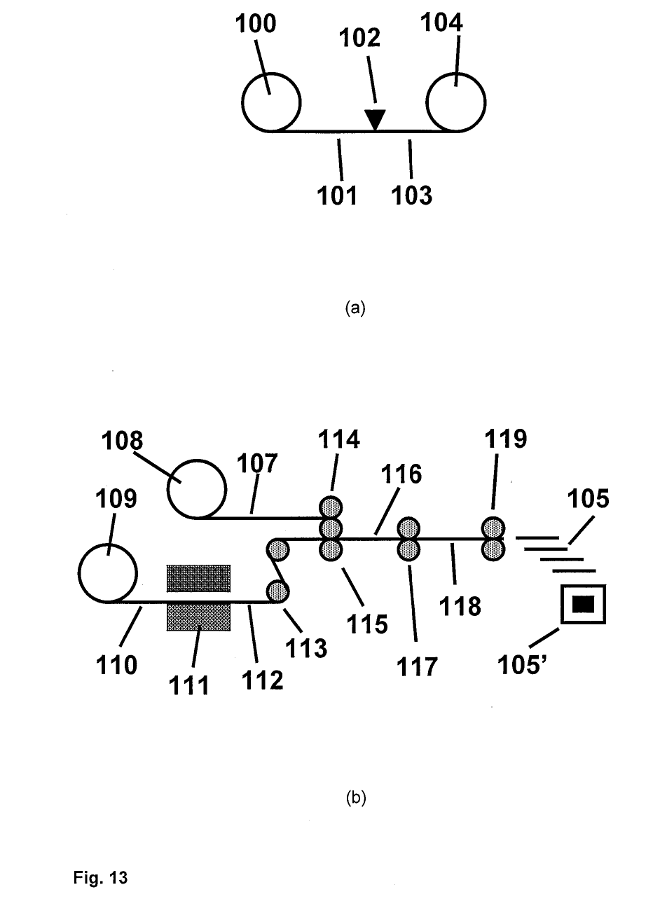

FIG. 13 illustrates a process for producing an assembly, shown on edge in 105 and in plan view from the top in 105′, according to an exemplary embodiments of the present invention such as those illustrated in FIGS. 1 and 2. A catalyzed membrane assembly 101 comprising a membrane and at least one electrode substantially covering at least one surface of the membrane is paid off of a first membrane spool 100. This membrane assembly is then slit to the desired final assembly width at 102 to produce a fully catalyzed membrane assembly (FCMA) 103, which is then spooled onto roll 104. The FCMA is then mated with the structural film layer as shown in FIG. 13(b). Although the process steps shown in FIG. 13(b) are shown as separate from those in FIG. 13(a) they could also be conducted in-line with those steps if desired. A structural film layer 110 is spooled off roll 109 and die cut to the desired shape, to produce a structural film layer 112 with a window in it. As described above, structural film layer 110 may have an adhesive on one side if desired. The structural film layer is then laminated to FCMA 107 as prepared in 13(a) off of roll 108 by cutting to length at 114, transferring the cut pieces at rollers 115 to the structural film layer 112 that has passed through rollers 113. Rollers 113 may be preheated (or in an oven) if desired to increase the tackiness of the structural film layer to improve bonding during the transfer step. The assembly 116, which has the FCMA placed over the window in the structural film layer, is then optionally further laminated using rollers 117, Again, heat may be used during the lamination step if desired. Finally, the FCMA with attached structural film layer 118 is cut to final length to produce discrete parts at cutter 119.

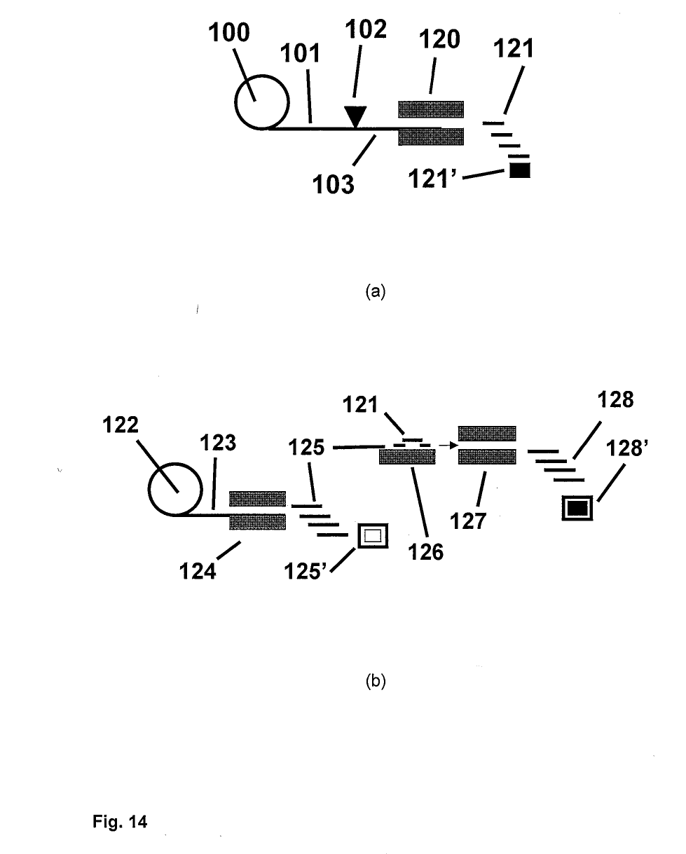

FIG. 14 illustrates a different process for producing an assembly shown in edge view in 128 and in plan view from the top in 128′ according to an exemplary embodiments of the present invention such as those illustrated in FIGS. 1 and 2. A catalyzed membrane assembly 101 comprising a membrane and at least one electrode substantially covering at least one surface of the membrane is paid off of a first membrane spool 100. This membrane assembly is then slit to the desired final assembly width at 102 to produce a fully catalyzed membrane assembly (FCMA) 103. The FCMA is then cut into discrete parts 121 using cutter 120. Cutter 120 may include any type of cutter known in the art, including but not limited to a rotary die cutter, a steel rule die cutter, a matched machine die, a laser cutter, or a slit and trim cutter. The collected FCMA parts 121 (also shown in plan view in 121′) are then mated with the structural film layer as shown in FIG. 14(b). Although the process steps shown in FIG. 14(b) are shown as separate from those in FIG. 14(a) they could also be conducted in-line with those steps if desired. A structural film layer 123 is spooled off roll 122 and cut into discrete “window-frame” parts, shown on edge as 125 and in plan view from the top as 125′ in cutter 124. Cutter 124 may include any type of cutter known in the art, including but not limited to a rotary die cutter, a steel rule die cutter, a matched machine die, a laser cutter, or a slit and trim cutter. As described above, structural film layer 123 may have an adhesive on one side if desired. The structural film layer parts 125 are mated to the FCMA parts 121 in a positioning fixture 126. The individual parts are then bonded in a lamination step 127 to produce the final parts illustrated in edge view as 128 and in plan view as 128′.

Further embodiments of the invention include processes for the production of assemblies where two structural films layers are used, such as those described in FIGS. 3-9. These processes follow the steps outlined in either FIG. 13 or FIG. 14, but differ in that a second structural film layer is mated to the CCM on the side opposite that of the first structural film layer. For example, using the process outlined in FIG. 13, a second structural film layer would be introduced with a second roll, cutter and rollers, similar to 109, 111, 113 respectively, and the cut CCM coming out of 114 would be placed at 115 between the two structural film layers. The two structural film layers used in this process may be cut so that the windows are the same size to produce assemblies such as those illustrated in FIGS. 3-4, or different sizes to produce assemblies such as those illustrated in FIGS. 5-9.

Alternatively, the process steps in FIG. 14 may be used directly except that two structural film layers 123 are produced for every CCM 122. The positioning fixture is modified to place the CCM 122 between two structural film layers 123. Again, the two structural film layers used in this process may be cut so that the windows are the same size to produce assemblies such as those illustrated in FIGS. 3-4, or different sizes to produce assemblies such as those illustrated in FIGS. 5-9.

In all of the illustrated embodiments, significant improvements are provided by structural film. It protects the assembly and provides structural support as described above, which produces a more durable, long-lasting assembly for fuel cells. Additionally, the use of the structural film layer and corresponding processes to produce the assemblies using it increases material utilization of expensive electrode materials, thereby reducing manufacturing costs. Further, the use of structural film layer as presented in the illustrative embodiments allows for high volume, high yield manufacturing of assemblies, leading to reduced assembly cost.

### EXAMPLES

### Example 1

A fully catalyzed membrane assembly according to the invention was prepared as follows:
1) A Series 5510 membrane electrode assembly with cathode and anode loading of 0.4 mg Pt/cm2 and 18 micron thick membrane (available from, W. L. Gore & Associates, Elkton, Md.) was die cut to a dimension of 51×53 mm using a steel rule die.
2) A window was die cut into a 102 micron (0.004 inch) thick piece of THV 220G film procured from Dyneon™ Fluorothermoplastics using a steel rule die. The window had the following dimensions: Internal window=48×46 mm, Outside border=90×100 mm.
3) The MEA was placed in the center of a 127 micron (0.005 inch) thick piece of polyimide film (Kapton® film) cut to the dimensions of 130×150 mm.
4) The internal window of the THV was then eye aligned to the MEA so that the MEA had approximately a 2.5 mm overlap all around. Additionally, the assembly was covered with another piece of 127 micron (0.005 inch) thick polyimide film cut to the dimensions 130×150 mm.
5) The assembled pieces were then placed on a transfer plate with the MEA oriented upwards. The transfer plate measured 12×12 inches on a side and consisted of a ⅛ inch thick aluminum base with a 3/16 inch thick silicone pad (MSC Industrial Supply PN 31938731) laid on the top surface. A 127 micron (0.005 inch) thick polyimide sheet was placed on the top pad surface to isolate the parts from the rubber.
6) The whole assembly was placed in a heated platen press (PHI Model Number Q230H) for approximately 10 sec with the upper platen heated to 180° C. under a pressure of approximately 100 pounds per square inch (psi).
7) After the press cycle was complete the part was removed and set aside to cool. The polyimide cover sheets were removed to reveal the successfully prepared fully catalyzed membrane assembly (FCMA).

### The resulting product showed the structural film layer was bonded to the MEA providing structural support to it.

### Example 2-3

These two examples illustrate that the thickness of the fluorothermoplastic can be varied to prepare FCMAs according to the invention. A product was prepared according to the procedure in Example 1 except that the THV film used in step 2 was prepared in-house by screw extrusion to prepare a thickness of 38 microns (0.0015 inches) for Example 2, and 25 microns (0.001 inches) for Example 3. In both cases, a successful product was prepared. The THV was bonded to the MEA and provided structural support to it.

### Example 4-8

These examples illustrate that various different thermoplastic materials can be used to prepare the inventive products. The procedure described Example 1 was used in Examples 4-8, except a 102 micron (0.004 inches) thick THV 500 film (3M, Minneapolis, Minn.), a 76 micron (0.003 inches) thick PVDF film Ajedium Film Group, Newark Del., a modified polyphenylene oxide material (Noryl® EN-265 film, Ajedium Film Group, Newark Del.) of 254 micron (0.010 inches) thickness, a different modified polyphenylene oxide material (Noryl® N300X film, Ajedium Film Group, Newark Del.) of 127 micron (0.005 inches) thickness, and a 25 micron (0.001 inches) thick EFEP film, were substituted respectively for the THV 200G of Example 1. Successful products were produced in each case. The thermoplastic material successfully bonded to the MEA and was provided support to it.

### Example 9

A further embodiment of the invention using an adhesive to bond the structural film layer to a fully catalyzed membrane electrode assembly was prepared as follows:
1. A Series 5510 membrane electrode assembly with cathode and anode loading of 0.4 mg Pt/cm2 and 18 micron thick membrane (W. L. Gore & Associates, Elkton, Md.) was die cut to a dimension of 51×53 mm using a steel rule die.
2. A 102 micron (0.004 inch) thick piece of Dyneon™ Fluorothermoplastics THV 220G film (3M Corporation, Minneapolis, Minn.) was laminated to a 25 micron (0.001 inch) thick piece of PEN (Teonex® Q51 DW obtained from DuPont Teijin Films, Hopewell, Va.) in a heated platen press by placing an 8×12 inch piece of the THV film on top of the same size PEN film surrounded by a layer of 0.005 inch thick polyimide film. This assembly was placed on the transfer plate as described in Example 1 and placed in the heated platen press as described in Example 1 for approximately 10 sec. The top platen was heated to approximately 140° C. and the clamping pressure set to 100 psi. After the cycle was complete the material was removed and set aside to cool. Once cooled the polyimide film was peeled back revealing the laminated composite.
3. The laminated composite from step 2 was die cut, using a steel rule die to the following dimensions: Internal window=48×46 mm, Outside border=90×100 mm.
4. The MEA was placed in the center of a 0.005 inch thick piece of polyimide film, cut to the dimensions 130×150 mm.
5. The internal window of the laminated film was then eye aligned to the MEA so that the MEA had approximately a 2.5 mm overlap all around. Additionally, the assembly was covered with another piece of 0.005 inch thick polyimide film cut to the dimensions 130×150 mm.
6. The assembled pieces were then placed on a transfer plate as in Example 1 with the MEA pointed upwards.
7. The whole assembly was placed in a heated platen press (PHI Model Number Q230H) for approximately 10 sec with the upper platen heated to 180 degrees C. under a pressure of 100 PSI.
8. After the press cycle was complete, the part was removed and set aside to cool. The polyimide cover sheets were removed to reveal the framed MEA.

The resulting product showed the structural film layer was fully bonded to the MEA providing structural support to it.

### Example 10

A product of the invention was produced as in Example 9 except before the structural film layer was laminated to the MEA, numerous small holes were randomly placed into the border area using a sharp instrument. The resulting product showed the structural film layer was fully bonded to the MEA providing structural support to it.

### Example 11

An additional embodiment of the invention that uses a structural film layer on both sides of the MEA was produced as follows:
1. A Series 5510 membrane electrode assembly with cathode and anode loading of 0.4 mg Pt/cm2 and 18 micron thick membrane (W. L. Gore & Associates, Elkton, Md.) was die cut to a dimension of 51×53 mm using a steel rule die.
2. Two 102 micron (0.004 inch) thick pieces of fluorothermoplastic (Dyneon™ Fluorothermoplastics THV 220G, 3M Corporation, Minneapolis, Minn.) were die cut using a steel rule die to the following dimensions: Internal window=48×46 mm, Outside border=90×100 mm.
3. The first layer of THV material was placed on top of a 125 micron (0.005 inch) thick piece of polyimide film cut to the dimensions 130×150 mm. The MEA was then aligned, by eye, to the inner window of the THV film so that the MEA had approximately a 2.5 mm overlap all around. Next, the second layer of THV was aligned, by eye, to the MEA so again the MEA had approximately a 2.5 mm overlap all around.
4. The whole assembly was covered with another piece of 125 micron (0.005 inch) thick polyimide film cut to the dimensions 130×150 mm.
5. The assembled pieces were placed on a transfer plate (see example 1) and moved into a heated platen press (PHI Model Number Q230H) for approximately 10 sec with the upper platen heated to 180° C. under a pressure of 100 PSI.
6. After the press cycle was complete the part was removed and set aside to cool. The polyimide cover sheets were removed to reveal the framed MEA that showed the structural film layers has bonded to the MEA and to each other, thereby providing support to the MEA.

### Example 12

A product was produced similar to that in Example 11 except the THV fluorothermoplastic had a PEN support layer applied to it's top surface. After placing the MEA between the two structural film layers, lamination was accomplished by passing the assembly between heated rollers. The MEA was bonded to the structural film layers and the layers provided support to it.

### Example 13

A product was produced using two structural film layers where the bonding to the MEA was affected by the use of an adhesive as follows:
1. A Series 5510 membrane electrode assembly with cathode and anode loading of 0.4 mg Pt/cm2 and 18 micron thick membrane (W. L. Gore & Associates, Elkton, Md.) was die cut to a dimension of 51×53 mm using a steel rule die.
2. A 102 micron (0.004 inch) thick THV 220G was laminated to a PEN film using the same procedure used in Example 2. In this example two approximately identical pieces were prepared.
3. The two pieces prepared in step 2 were both steel rule die cut to the following dimensions: Internal window=48×46 mm, Outside border=90×100 mm.
4. The MEA was placed on a cover sheet of 125 micron (0.005 inch) thick polyimide and one of the frames was eye aligned to the MEA to reveal an approximate 2.5 mm overlap all around. This lay-up was then covered with another sheet of 125 micron (0.005 inch) thick polyimide and placed on the transfer plate as described in Example 1 with the MEA upward.
5. The part was heated and pressed for approximately 5 sec with a platen temperature of approximately 150 degrees C. under a pressure of 50 psi.
6. After the cycle was complete the lay-up was removed from the press and set aside to air cool. The polyimide sheet on the MEA side of the part was then peeled off.
7. The second frame from step 2 was eye aligned to the MEA with the THV facing the MEA. Alignment consisted of registering the frame inner window to the outer border of the MEA to reveal a 2.5 mm overlap all around.
8. Another sheet of 125 micron (0.005 inch) thick polyimide was placed on top of the newly placed frame.
9. The whole assembly was placed on the transfer plate as described in Example 1 and positioned in the heated platen press.
10. The part was heated and pressed for approximately 10 sec with a platen temperature of approximately 180 degrees C. under a pressure of 100 psi.
11. After the press cycle the lay-up was removed from the press, set aside to air cool and then peeled from the polyimide sheets.

The resulting MEA was bonded to the structural film layers and the layers provided support to it.

### Example 14

Another embodiment of the invention was produced in this Example. Here, two structural film layers were used with bonding affected by adhesive, but only one of the structural film layers overlaps the electrode. The procedure was as follows:
1. A Series 5510 membrane electrode assembly with cathode and anode loading of 0.4 mg Pt/cm2 and 18 micron thick membrane (W. L. Gore & Associates, Elkton, Md.) was die cut to a dimension of 51×53 mm using a steel rule die.
2. A 102 micron (0.004 inch ) THV 220G thick film was laminated to PEN as described in Example 9, step 2.
3. A 25 micron (0.001 inch) thick PEN film was steel rule die cut to the following dimensions: Inner window=55×56 mm, Outer border=90×100 mm.
4. The PEN layer from step 3 was laminated to the layer from step 2 by laying the single PEN on the THV side of the PEN+THV laminate. This assembly was then placed between two pieces of 125 micron (0.005 inch) thick polyimide sheets and laid on the transfer plate with the single PEN oriented upward. This lay-up was then placed in a platen press for approximately 5 sec with the top platen temperature of 180° C. and a pressure of 100 PSI. After the cycle was complete the part was removed and placed aside to cool. Polyimide cover layers were peeled from the assembly revealing the laminated lay-up.
5. The assembly from step 4 was then die cut using a steel rule die to the following dimensions: Outer perimeter 90×100 mm and an inner window of 46×48 mm.
6. The MEA was placed on a cover sheet of 125 micron (0.005 inch) thick polyimide and the frame from step 5 was aligned to the MEA so there was an approximate 2.5 mm overlap of the frame to the MEA. This lay-up was then covered with another sheet of 125 micron (0.005 inch) thick polyimide and placed on the transfer plate with the MEA oriented upward.
7. The part was heated and pressed for approximately 10 sec with a platen temperature of approximately 180 degrees C. under a pressure of 100 psi.
8. After the cycle was complete the lay-up was removed from the press, and set aside to air cool. Polyimide sheets were then peeled from the assembly.

The resulting MEA was bonded to the structural film layers and the layers provided support to it.

### Example 15

Another product of the invention was prepared in this Example illustrating the application of gas diffusion layers to the assembly as follows:
1. A Series 5510 membrane electrode assembly with cathode and anode loading of 0.4 mg Pt/cm2 and 18 micron thick membrane (W. L. Gore & Associates, Elkton, Md.) was die cut to a dimension of 51×53 mm using a steel rule die.
2. A 102 micron (0.004 inch) thick piece of THV 220G film was laminated to a 25 micron (0.001 inch) thick piece of PEN.

Lamination was accomplished in a heated platen press by placing an 8×12 inch piece of the THV film on top of the same size PEN film surrounded by a layer of 0.005 inch thick polyimide film. This assembly was placed on the transfer plate (see example 1) and inserted into the heated platen press for approximately 10 sec. The top platen was heated to approximately 140° C. and the clamping pressure set to 100 psi. Upon completion of the cycle the material was removed and set aside to cool. Once cooled the polyimide film was peeled back revealing the one sided laminated composite. Now another piece of THV was placed on the opposite side of the lay-up creating a THV+PEN+THV composite. Again, this lay-up was placed between two polyimide sheets and positioned on the transfer plate. The transfer plate was inserted in the heated platen press for 10 sec with the top platen heated to 140° C. under a pressure of approximately 100 psi. Upon completion of the cycle the laminate was removed from the press and allowed to cool. Both polyimide sheets were peeled back to reveal the laminate.
3. The laminated composite from step 2 was die cut, using a steel rule die to the following dimensions: Internal window=48×46 mm, Outside border=90×100 mm.
4. The MEA was placed in the center of a 125 micron (0.005 inch) thick piece of polyimide film, cut to the dimensions 130×150 mm.
5. The internal window of the laminated film was then eye-aligned to the MEA so the MEA had approximately a 2.5 mm overlap all around. The assembly was then covered with another piece of 125 micron (0.005 inch) thick polyimide film cut to the dimensions 130×150 mm.
6. The assembled pieces were placed on a transfer plate (see example 1) with the MEA orientated upwards.
7. The whole assembly was inserted in a heated platen press (PHI Model Number Q230H) for approximately 10 sec with the upper platen heated to 180 degrees C. under a pressure of 100 PSI.
8. After the press cycle was complete, the part was removed and set aside to cool. The polyimide cover sheets were removed to reveal the framed MEA.
9. Two pieces of gas diffusion layers (SIGRACET® Gas Diffusion Media 25BC obtained from SGL Technologies GmbH.GDL) were die cut to the dimensions 55×57 mm.
10. The framed MEA was placed on the 125 micron (0.005 inch) thick polyimide sheet with the MEA orientated upwards. One of the GDL pieces was aligned over the MEA so that the GDL completely covered the MEA. A second sheet of 125 micron (0.005 inch) thick polyimide was placed on top of the lay-up.
11. This assembly was placed on the transfer plate (see example 1) and inserted into the heated platen press for a duration of approximately 5 sec. The top platen was heated to a temperature of 180 degrees C. and a clamping pressure of 100 psi. After completion of the cycle the assembly was removed and set aside to cool.
12. Once cooled, the bottom cover sheet was removed and the second piece of GDL was aligned to cover the MEA on the opposite surface. This assembly was covered with a 125 micron (0.005 inch) thick piece of polyimide and placed on the transfer plate (see example 1) for insertion into the heated platen press.
13 . The press cycle was approximately 10 sec with a platen temperature of approximately 180 degrees C. under a pressure of 100 psi.
14 . After the cycle was complete the lay-up was removed from the press, and set aside to air cool.
15. Once cooled the coversheets were removed and the part was revealed.

The resulting membrane electrode assembly had gas diffusion layers bonded to it, and it was supported on the edges by the structural films layers.

While the present invention has been described in connection with certain preferred embodiments, the scope of the invention is not intended to be limited thereby. Rather, the invention is to be given the scope defined in the appended claims.

1. An assembly comprising:
a. a solid polymer electrolyte membrane having opposed faces;
b. an electrode comprising a catalyst covering at least one of said faces of said solid polymer electrolyte membrane and being co-extensive with said polymer electrolyte membrane to form a fully catalyzed membrane assembly having multiple sides; and
c. a structural film layer bonded to at least two opposing sides of said fully catalyzed membrane assembly, said structural film layer partially overlapping said electrode.

2. An assembly as defined in claim 1 wherein said structural film layer is bonded to all sides of said electrode.

3. An assembly as defined in claim 1 further comprising a gas sealing means to bond said structural film to said fully catalyzed membrane assembly.

4. An assembly as defined in claim 3 wherein said gas sealing means comprises said structural film layer imbibed into at least a portion of said electrode.

5. An assembly as defined in claim 3 wherein said gas sealing means comprises an adhesive.

6. An assembly as defined in claim 5 wherein said adhesive imbibes at least a portion of said outer portion of said electrode.

7. An assembly as defined in claim 6 wherein said solid polymer electrolyte comprises a perfluorosulfonic acid ionomer.

8. An assembly as defined in claim 7 wherein said solid polymer electrolyte further comprises expanded polytetrafluoroethylene.

9. An assembly as defined in claim 8 wherein said structural film layer comprises polyethylene naphthalate.

10. An assembly as defined in claim 9 wherein said adhesive comprises a fluorothermoplastic comprising tetrafluoroethylene.

11. An assembly as defined in claim 5, wherein said assembly includes at least one gas diffusion layer.

12. An assembly as defined in claim 11 wherein said assembly further includes a sealing gasket.

13. An assembly as defined in claim 1 wherein said electrode is an anode and said structural film layer overlaps said anode.

14. An assembly as defined in claim 1 wherein said electrode is an anode and said structural film layer overlaps said cathode.

15. An assembly as defined in claim 1 wherein said structural film layer extends beyond an edge of said fully catalyzed membrane assembly.

16. A catalyst coated membrane assembly comprising:
a. a solid polymer electrolyte membrane having two faces;
b. a first electrode that covers substantially the entire first face of said polymer electrolyte membrane;
c. a second electrode that covers substantially the entire second face of said polymer electrolyte membrane;
d. a first structural film layer attached to at least two opposing outer regions of said first electrode such that it partially overlaps the open face of the electrode to which it is attached; and
e. a second structural film layer attached to either (i) at least two opposing outer regions of said second electrode such that it partially overlaps the open face of the electrode to which it is attached; or (ii) said first structural film layer; or both (i) and (ii).

17. A catalyst coated membrane of claim 16 wherein either the first structural film layer or the second structural film layer or both overlap all outer regions of said electrode.

18. A catalyst coated membrane of claim 16 wherein at least one of the first and second structural film layers are attached to said first or second electrodes with an adhesive.

19. A catalyst coated membrane of claim 16 wherein said first or said second structural film layer imbibes at least a portion of said outer regions of said first or said second electrode to which it is attached.

20. A catalyst coated membrane of claim 17 wherein said first or said second structural film layer is attached to said first or said second electrode with an adhesive.

21. A catalyst coated membrane of claim 20 wherein said adhesive imbibes at least a portion of said outer portion of either said first electrode or said second electrode.

22. A catalyst coated membrane of claim 21 wherein said solid polymer electrolyte comprises a perfluorosulfonic acid ionomer.

23. A catalyst coated membrane of claim 22 wherein said solid polymer electrolyte further comprises expanded polytetrafluoroethylene.

24. A catalyst coated membrane of claim 23 wherein said first or said second structural film layer or both comprises polyethylene naphthalate.

25. A catalyst coated membrane of claim 24 wherein said adhesive comprises a fluorothermoplastic comprising tetrafluoroethylene.

26. An assembly using the catalyst coated membrane of claim 20, wherein said assembly includes at least one gas diffusion layer.

27. As assembly of claim 26 wherein said assembly further includes a sealing gasket.

28. A process for producing an assembly comprising
a. providing a fully catalyzed membrane assembly comprising a solid polymer electrolyte membrane, and attached to said solid polymer electrolyte membrane at least one electrode having an open face and outer regions;
b. attaching a structural film layer to at least two opposite outer regions of said electrode such that said structural film layer partially overlaps the open face of said electrode.

29. A process for producing an assembly as defined in claim 28 wherein attaching the structural film layer in step (b) comprises using an adhesive.

30. The process of claim 29 wherein the adhesive is a thermoplastic polymer.

31. The process of claim 30 wherein the adhesive comprises a fluorothermoplastic comprising tetrafluoroethylene.

32. A process for producing an assembly as defined in claim 28 further comprising (c) applying a gas diffusion layer to at least one of said electrodes.

33. A process for producing an assembly as defined in claim 28 further comprising (c) applying a sealing gasket to said structural film layer.

34. A process for producing an assembly as defined in claim 32 further comprising (d) applying a sealing gasket to said structural film layer.

35. A fuel cell comprising the assembly of claim 1.

36. A fuel cell comprising the catalyst coated membrane of claim 15.
